(19) United States
(12) Patent Application Publication
(10) Pub. No.: US 2012/0021207 A1
(43) Pub. Date: Jan. 26, 2012

(54) POWDER COATING

(75) Inventors: Justin Martin, Ramsey (IM); Peter McArthur, Tauranga (NZ); Anthony Corlett, Castletown (IM); Roy Tilleard, Colby (IM)

(73) Assignee: Lorne House Limited, Isle Of Man (GB)

(21) Appl. No.: 12/764,381

(22) Filed: Apr. 21, 2010

Related U.S. Application Data
(63) Continuation of application No. PCT/GB08/50874, filed on Sep. 26, 2008.

(30) Foreign Application Priority Data
Oct. 9, 2007 (GB) 0719692.6

(51) Int. Cl. B32B 21/04; B27K 3/00; B05D 3/02; B05D 1/36; B05D 3/06

(52) U.S. Cl. 428/332; 427/202; 427/558; 428/541

(57) ABSTRACT

There is herein described powder coated wood products and methods of producing powder coated wood products. More particularly, there is herein described powder coated chemically modified wood which is highly durable.

### FIELD OF THE INVENTION

The present invention relates to powder coated wood products and methods of producing powder coated wood products. More particularly, the present invention relates to powder coated chemically modified wood which is highly durable.

### BACKGROUND OF THE INVENTION

Although there are previous methods of obtaining powder coated timber products these produce products with pin holes, crazing, low adhesion, charred wood, cupping (i.e. bending of the wood) etc.

It is an object of at least one aspect of the present invention to obviate or mitigate at least one or more of the aforementioned problems.

It is a further object of at least one aspect of the present invention to provide a powder coated timber product which has improved properties such as: reduced (or no) emissions; one-step process; one-coat process; elimination of edge banding; significant reduction of exhaust and oven ventilation air; minimal drying time (i.e. eliminating the drying oven and associated energy use and floor space); reduced labour via increased automation; and high durability and chemical resistance.

In its application, powder coated timber offers improved properties such as reduced maintenance, no hand finishing required thereby providing significant cost savings, chip resistance, scratch resistance, improved machine-ability, weather resistance and improved sand-ability. Most timber shapes and profiles can be successfully powder coated with adjustments to the powder formulation, flow, gun and/or lamp placement (for UV curing).

It is a yet further object of the present invention to provide a powder coated timber product which has a smooth non-porous finish.

### SUMMARY OF THE INVENTION

According to a first aspect of the present invention there is provided a method of providing a powder coated wood product, said method comprising:
(a) providing a member of non-engineered soft wood;
(b) then impregnating the member of non-engineered soft wood with a chemical to provide a chemically modified wood member;
(c) then heating and charging the chemically modified wood member;
(d) then applying a powder coating to the heated and charged chemically modified wood member; and
(e) then at least partially curing the powder coating to provide a powder coated non-engineered soft wood product.

The term wood as herein described is also intended to cover timber or lumber, which is either standing or which has been processed for use. In the U.K. and Australia, “timber” is a term also used for sawn wood products (that is, planks or boards), whereas generally in the United States and Canada, the product of timber cut into planks or boards is referred to as lumber. For example, the wood may be a soft wood and may be selected from pines, hemlocks and aspen woods.

In particular, the present invention does not relate to mechanically engineered wood such as Medium Density Fibreboard, (MDF commonly known as Customwood or Craftwood), Oriented Strand Board, (OSB), plywood or particle board. The present invention specifically relates to powder coating chemically modified wood (i.e. non-engineered wood). The present invention also in contrast to previous powder coating wood techniques only requires a single powder coating step to provide surprising technical advantages such as reduced maintenance, no hand finishing required thereby providing significant cost savings, chip resistance, scratch resistance, improved machine-ability, weather resistance and improved sand-ability.

The member of wood is impregnated with a chemical. The chemical may or may not react with the member of wood and may, for example, be an aqueous formulation of copper or sodium borate preservatives, furfuryl or acetic acid, creosote, oil-borne (penta), wax, silica or cellulose based chemicals. The chemical may be sprayed on using, for example, a jet or brushed onto the member of wood. Alternatively, the member of wood may be dipped or immersed into a bath or pressure treatment vessel together with the chemical and treated so that between about 1 kg per cubic meter and about 10.0 kg per cubic meter (about 0.06 pcf and about 0.6 pcf (pounds of chemical per cubic foot)) 1.6 kg per cubic meter and about 6.4 kg per cubic meter (about 0.1 pcf and about 0.4 pcf (pounds of chemical per cubic foot)), remains in the wood after the treatment process is complete.

In preferred embodiments, pressure treatment may be used to impregnate the chemical into the member of wood. Pressure treatment is a process that forces chemicals into the wood. Wood may be placed inside a closed cylinder, then vacuum and pressure may be applied to force the chemicals into the wood. Pressure treatment is commonly used with preservative chemicals such as “waterborne”, “creosote”, and “oil-borne (penta)” broad classes of preservatives. Several typical waterborne preservatives used in building applications include: Chromated Copper Arsenate (CCA-C); Alkaline Copper Quat (ACQ-C, ACQ-D, ACQ-D Carbonate); Copper Azole (CBA-A & CA-B); and Sodium Borates (SBX/DOT).

Retention level refers to the amount of chemical such as preservative that remains in the wood after the treatment process is complete. It is measured on a weight basis and is typically expressed as kilograms per cubic metre (or pounds of preservative per cubic foot (pcf)) of wood.

The chemical deposited onto the member of wood may improve the ability of the powder coating to adhere to an outer surface of the member of wood. The chemical may therefore improve adhesion of the powder coating by, for example, use of chemical bonds between the chemical on the outer surface of the member of wood and the powder coating.

The member of wood may be wood obtained directly from cutting from a felled tree. The member of wood may be a plank of wood, door frame, window frame, construction beam, barge pole etc.

After treatment with the chemical, the wood may then be dried in a kiln by applying temperatures above room temperature of, for example, up to about 50° C., 70° C., 100° C., 120° C., 140° C., 160 C. Alternatively, after treatment with the chemical, the wood may then be dried in a kiln by applying temperatures of up to about 50-200° C., about 60-150° C. or about 60-100 C. In particular embodiments, the wood may then be dried in a kiln by applying temperatures of up to about 60° C. (140° F.) to about 116° C. (240° F.) depending on the species of wood and the chemical introduced in the treatment process.

A powder coating may then be applied to the heated chemically treated wood using any suitable means. As used herein, “powder coating” includes or refers to any procedure where electro-static attachment of a coating material (“powder”) is involved irrespective of whether or not the coating material is in a solids and/or liquid form (i.e. a true powder) prior to any cure or drying thereof.

Reference herein to a “powder” (subject to the foregoing comment in respect of powder coating) preferably includes any powder of a kind capable of at least a partial cure under the action of heat such as that derived from an IR (infrared) source and/or melted and/or melded with an IR heating source and being cured in that molten and/or the post molten state under the action of, for example, a UV source.

Reference herein to “preheating” is preferably (but not necessarily) to ensure sufficient conductivity for subsequent powder deposition reliant on electrostatic attachment. Likewise, partial cure heating, etc.

As used herein “cure” (and related words such as “curing”) includes polymerisation, etc. or other chemical reformation, irrespective of whether or not to completion.

As used herein, the terms “pulse” or “pulsed” mean, in respect of exposure to infrared radiation, subjection to oscillating heat and relaxation periods (“Oscillating Relaxation Periods” or “ORP”). During the relaxation period or periods (arising from movement relative to plaques, or vice versa, rather than heating control of the plaques) the energy absorbed by the coating (immediate surface of the product exposed) may be allowed to uniformly disperse across the previously irradiated surface.

The wood may be heated using any suitable heat source or a plurality of heat sources. For example, the heat source may be a pulsing IR radiant heat source. Importantly, the wood does not de-gas when exposed to any heating incurred in the powder coating process. The wood also does not emit water (i.e. it is sealed) and does not char, produce smoke or change dimension when exposed to smoke.

Typically, the member of wood may be moved continuously using, for example, belt driven means through and/or along the heat source(s). Alternatively, but less preferred, the relative movement may be intermittent.

In a particular embodiment, the heating of the member of wood may be with an IR radiant heat source or sources and there may be movement of the member of wood relative thereto.

Typically, the heat sources may be stationary. Preferably, the wood product may be carried by a conveyor.

Typically, the IR sources may be intermittent or variable in output.

In further embodiments of the present invention, there may be a method of coating a chemically engineered and/or modified wood member which comprises or includes the steps of pre-heating with IR heating a surface of the chemically engineered and/or modified wood member, applying a coating of a powder to the heated surface and at least partially curing the powder coating with infrared heating, and thereafter UV curing that coating, wherein the infrared heating step involves movement relative to spaced IR sources.

Typically, in one or more of the pre-heating, partial curing and curing steps IR radiation may be used serially or intermittently so as to provide temperature relaxation (preferably ORP).

Preferably, said IR radiant heat may be intermittent (pulses) or variable from its plaques. Preferably, the plaques are spaced so as to provide oscillating relaxation periods (“ORP”) even though an IR oven with pulsing plaques may be preferred.

Optionally and preferably the preheating may be with IR heat.

Optionally such partial cure may be with IR radiant heat in, for example, an IR oven (optionally with pulsing plaques) preferably with ORP. Optionally such at least partial cure may be with infrared radiant heat in, for example, an IR oven.

In a further embodiment, the present invention may consist in the use of pulsed (i.e. to provide ORP) (or varying or intermittent) IR heat to treat the powder application to a heat activated substrate (optionally with UV curing of the outer layer).

The powder(s) used can be any one of or combination of the most common polymers such as polyester, polyester-epoxy (known as hybrid), straight epoxy (fusion bonded epoxy), acrylics, plastic derived coating, water based powder coatings or an organic based powder coatings.

In particular embodiments, the powder may include additional components that may contain flexibility modifying additives, for example, those based on core/shell acrylic rubber.

The powder may be coated in any appropriate thickness range such as about 1 to 10,000 μm (0.04 to 400 mils), about 10 to 5,000 μm (0.4 to 200 mils), about 13 to 1,000 μm (0.5 to 40 mils) or about 100 to 500 μm (4 to 20 mils). The thickness and type of the powder coating may be adapted for different uses. The weight and amount of the powder coating may be adapted for different uses.

A final curing and/or drying step may be performed using, for example, UV radiation.

According to a second aspect of the present invention there is provided a powder coated wood product, said powder coated wood product comprising:

a member of non-engineered soft wood;

said member of non-engineered soft wood being at least partially impregnated with a chemical; and

at least a portion of an outer surface of the member of non-engineered soft wood being at least partly coated with a cured powder coating.

The powder coated wood product may be as formed in the first aspect.

The powder coated wood product may be used in a variety of uses where timber products are used externally such as soffets, window frames, cills, doors and door frames, conservatories, barge boards, fascia boards garden sheds, decking and timber framed buildings and the like.

In particular embodiments, only one cured powder coating may be required to provide the desired results.

The final thickness of the powder coating may be about 1 to 10,000 μm (0.04 to 400 mils), about 10 to 5,000 μm (0.4 to 200 mils), about 13 to 1,000 μm (0.5 to 40 mils) or about 100 to 500 μm (4 to 20 mils).

The member of wood used in the present invention may be a soft wood but after treatment according to the present invention has many of the properties of a hard wood. As is well known, the use of hard woods is restricted due to their expense and time to grow such trees. The present invention therefore also provides significant conservation benefits as it reduces the use of hard woods.

### BRIEF DESCRIPTION

The present invention relates to providing powder coated wood.

In preferred embodiments a member of pine may be used. The pine is impregnated with about 3.2 kg per cubic meter (0.2 pcf) with a chemical using a pressure treatment vessel. The impregnated pine is then loaded onto a conveyor line and any loose particles are removed from the surface using air jets, a de-nibbler, brush or the like. This process provides a smooth surface, free from objects that would disrupt the final coated film.

The impregnated pine is then passed through a booster oven. This booster oven is preferably IR heating (with or without ORP) but could also be convection heating or a combination IR/convection. The booster oven raises the temperature to a predetermined level prior to powder coating such as about 70° C.

A powder coating of low temperature baked polyester is then deposited using electro-static attachment where the wood has one charge and the powder has the opposite charge.

The powder coating has a depth of about 13 to 1000 microns.

A final curing step using UV radiation is used.

The finished product has a substantially smooth non-porous finish, does not require a final finishing step such as sanding. The finished product has further technical advantages such as chip resistance, scratch resistance, improved machine-ability, weather resistance and improved sand-ability. Wood products made in accordance with the present invention may be guaranteed for a lifetime of at least 15 years with little or no maintenance when exposed to the weather.

Whilst specific embodiments of the present invention have been described above, it will be appreciated that departures from the described embodiments may still fall within the scope of the present invention. For example, any suitable type of electro-static deposition technique may be used to deposit the powder coating. The depth and thickness of the powder coating may be adapted and changed for different uses. Moreover, any suitable type of powder coating may be used. Furthermore, any appropriate type of soft wood may be used.

1-24. (canceled)

25. A method of providing a powder coated wood product, said method comprising:
providing a member of wood;
impregnating the member of wood with a chemical to provide a chemically modified wood member;
heating and charging the chemically modified wood member;
applying a powder coating to the heated and charged chemically modified wood member; and
at least partially curing the powder coating to provide the powder coated wood product.

26. A method of providing a powder coated wood product according to claim 25, wherein the wood is selected from a suitable treatable timber species and is not mechanically engineered.

27. A method of providing a powder coated wood product according to claim 25, wherein the wood is a soft wood such as pines, hemlocks, aspen, beach and birch wood.

28. A method of providing a powder coated wood product according to claim 25, wherein there is only one powder coating step.

29. A method of providing a powder coated wood product according to claim 25, wherein the chemical impregnating the member of wood is selected from any of the following: aqueous formulation of copper or sodium borate preservatives, furfuryl or acetic acid, creosote, oil-borne (penta), wax, silica or cellulose based chemicals.

30. A method of providing a powder coated wood product according to claim 25, wherein the chemical impregnating the member of wood is sprayed on using a jet, brushed on or forced on using a pressure system, or the member of wood is dipped or immersed in a bath of the chemical.

31. A method of providing a powder coated wood product according to claim 25, wherein the chemical deposited onto the member of wood improves the ability of the powder coating to adhere to an outer surface of the member of wood.

32. A method of providing a powder coated wood product according to claim 25, wherein the wood is heated in a preheating step to about 140° F. to 240° F. using any suitable heat source or a plurality of heat sources or infrared radiant heat source.

33. A method of providing a powder coated wood product according to claim 25, wherein the member of wood is moved continuously using belt driven means through and/or along a heat source(s).

34. A method of providing a powder coated wood product according to claim 25, wherein the powder(s) used is one of or a combination of the following: polyester; polyester-epoxy (known as hybrid); straight epoxy (Fusion bonded epoxy), acrylics, plastic derived coating, water based powder coatings or an organic based powder coatings.

35. A method of providing a powder coated wood product according to claim 25, wherein the powder includes additional components that contain flexibility modifying additives or flexibility modifying additives including that of core/shell acrylic rubber.

36. A method of providing a powder coated wood product according to claim 25, wherein the powder coating is fully cured using UV radiation.

37. A powder coated wood product formed according to claim 25, said powder coated wood product comprising:
a member of wood;
said member of wood being at least partially impregnated with a chemical; and
at least a portion of an outer surface of the member of wood being at least partly coated with a cured powder coating.

38. A powder coated wood product according to claim 37, wherein the thickness of the powder coating is about 13 to 1,000 μm (0.5 to 40 mils).

39. A powder coated wood product according to claim 13, wherein the wood is a soft wood.

40. A powder coated wood product according to claim 39, wherein the wood is selected from the group consisting of pines, hemlocks, aspen, beach and birch woods.

41. A powder coated wood product according claim 14, wherein the wood is a soft wood.

42. A powder coated wood product according to claim 40, wherein the wood is selected from the group consisting of pines, hemlocks, aspen, beach and birch woods.
